(19) United States
(12) Patent Application Publication
(10) Pub. No.: US 2021/0213833 A1
(43) Pub. Date: Jul. 15, 2021

(54) VOLTAGE BASED SHORT CIRCUIT DETECTION BY ON BOARD AUTOMOTIVE BATTERY CHARGER

(71) Applicant: Ford Global Technologies, LLC, Dearborn, MI (US)

(72) Inventors: Rajesh Narayanan, Canton, MI (US); Mohamed Elshaer, Canton, MI (US)

(21) Appl. No.: 16/741,441

(22) Filed: Jan. 13, 2020

(51) Int. Cl. B60L 3/00; H02J 7/04; B60L 53/18; H02J 7/00; B60L 55/00

(52) U.S. Cl. CPC B60L 3/0046; H02J 7/04; B60L 55/00; H02J 7/007182; B60L 53/18

(57) ABSTRACT

An automotive vehicle includes a traction battery and an on board battery charger that can be electrically connected with an off board AC grid via a charge cable that includes a charge circuit interrupt device. The on board battery charger attenuates a fundamental component of a voltage signal associated with power from the AC grid to generate an AC signal that has a bias value corresponding to a voltage on the AC grid. The on board battery charger also issues a command to open contactors of the charge circuit interrupt device responsive to a minimum value of the AC signal being less than a predetermined threshold value.

### TECHNICAL FIELD

This disclosure relates to AC charging systems for battery electric vehicles or plug-in hybrid electric vehicles.

### BACKGROUND

Electrified vehicles, such as hybrid, plug-in hybrid, and battery electric vehicles use an electric machine powered by a traction battery to drive the vehicle powertrain. The traction battery, in certain configurations, may be charged with power from an AC grid. Parameters, such as voltage, associated with the AC grid may vary with time of day, etc.

### SUMMARY

An automotive vehicle includes a traction battery and an on board battery charger. The on board battery charger can be electrically connected with an off board AC grid via a charge cable that is connected between the automotive vehicle and AC grid and that includes a charge circuit interrupt device. The on board charger attenuates a fundamental component of a voltage signal associated with power from the AC grid to generate an AC signal that has a bias value corresponding to a voltage on the AC grid, and issues a command to open contactors of the charge circuit interrupt device responsive to a minimum value of the AC signal being less than a predetermined threshold value.

The on board battery charger may include a rectifier, a non-isolated DC-DC boost converter, and a voltage sensor connected between the rectifier and non-isolated DC-DC boost converter that measures the voltage signal. The on board battery charger may further include an isolated DC-DC boost converter and power factor correction circuitry connected between the non-isolated DC-DC boost converter and isolated DC-DC boost converter. The on board battery charger may further include a filter that performs the attenuation of the fundamental component of the voltage signal. The filter may be a low pass filter. The on board battery charger may further include a comparator that compares the minimum value with the predetermined threshold. The on board battery charger may further include a controller that generates the command.

An on board battery charger of an automotive vehicle can be electrically connected with an off board AC grid via a charge cable that is connected between the automotive vehicle and AC grid and that includes a charge circuit interrupt device. A method of operating the on board battery charger includes attenuating a fundamental component of a voltage signal associated with power from the AC grid to generate an AC signal that has a bias value corresponding to a voltage on the AC grid, and issuing a command to open contactors of the charge circuit interrupt device responsive to a minimum value of the AC signal being less than a predetermined threshold value.

The method may further include measuring the voltage signal. Attenuating the fundamental component of the voltage signal may include filtering the fundamental component of the voltage signal. Filtering the fundamental component of the voltage signal may include low pass filtering the fundamental component of the voltage signal. The method may further include comparing the minimum value with the predetermined threshold.

An automotive vehicle includes a traction battery and an on board battery charger that can be electrically connected with an off board AC grid via a charge cable that includes a charge circuit interrupt device. The on board battery charger includes a voltage sensor that measures a voltage signal associated with power from the AC grid, a filter that attenuates a fundamental component of the voltage signal to generate an AC signal that has a bias value corresponding to a voltage on the AC grid, a comparator that compares a minimum value of the AC signal with a predetermined threshold, and a controller that issues a command to open contactors of the charge circuit interrupt device responsive to the minimum value being less than a predetermined threshold.

The on board battery charger may further include a rectifier and a non-isolated DC-DC boost converter. The voltage sensor may be connected between the rectifier and non-isolated DC-DC boost converter. The on board battery charger may further include an isolated DC-DC boost converter and power factor correction circuitry connected between the non-isolated DC-DC boost converter and isolated DC-DC boost converter. The filter may be a low pass filter. The on board battery charger may further include a set-reset latch configured to receive input from the comparator and generate output for the controller.

### BRIEF DESCRIPTION OF THE DRAWINGS

FIG. 1 is a schematic diagram of a typical charging system.

FIG. 2 is a schematic diagram of components within the charge circuit interrupt device of FIG. 1.

FIG. 3 is a schematic diagram of a proposed charging system having voltage sense circuitry within an on board charger.

FIG. 4 is a flow chart of an algorithm for operating the on board charger of FIG. 3.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Current short circuit detection systems use traditional hall effect or shunt based current sensors in the cord set to detect a short circuit during charging of an electrified vehicle that is using a 110V/220V outlet or public charging station. A current sensor within the charge circuit interrupt device monitors the current during normal operation. If a short occurs, the increased current is detected, and contactors are opened. This, however, can result in increased cost in the system. A current sensor for Level 1 charging is typically rated up to 20 A, but UL-standard tests require it to withstand 20,00 A for 3 ms due to a low resistance ground fault condition driving further cost to the system.

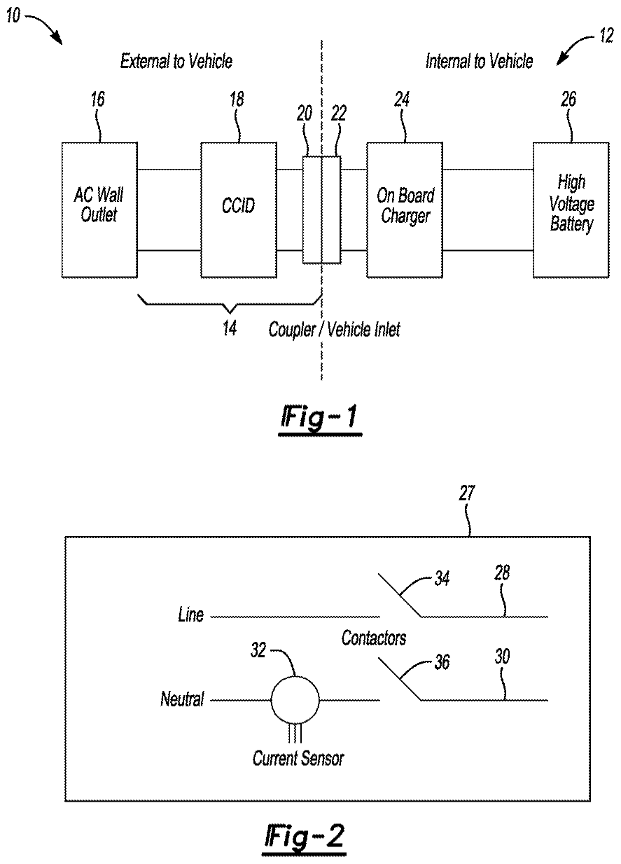

In a typical vehicle charging system, the infrastructure outlet (garage outlet) is connected through a charge circuit interrupt device, which then connects to the vehicle on board charger through a coupler/inlet port. FIG. 1, for example, shows a charging system 10 for a vehicle 12. The charge system 10 includes a cord set 14 connected with an AC wall outlet 16. The cord set 14 includes a charge circuit interrupt device 18 and a coupler 20. The vehicle 12 includes a vehicle inlet 22, an on board charger 24, and a high voltage battery 26. The coupler 20 and vehicle inlet 22 mate with each other to establish an electrical connection between the AC wall outlet 16 and on board charger 24. Power from the AC wall outlet 16 delivered to the on board charger 24 via the cord set 14 during normal charging can then be used by the on board charger 24 to charge the high voltage battery 26.

Charge circuit interrupt device modules are typically designed with a current sensor to monitor current flow. The current sensor is installed either on the phase or neutral line to monitor the current flow between the home outlet and vehicle charging system. FIG. 2 shows a conventional charge circuit interrupt device 27 including phase and neutral lines 28, 30, a current sensor 32, and contactors 34, 36. The current sensor 32 is arranged to detect current on the neutral line 30. The contactors 34, 36 are respectively arranged on the phase and neutral lines 28, 30. Responsive to current detected by the current sensor 32 exceeding some threshold, the contactors 34, 36 can be opened to interrupt current flow.

Here, an on board charger is proposed that has voltage detection capability that can be utilized to monitor input voltage (after initial rectification stage) to recognize a fault condition and send a message to a charge circuit interrupt device to open its contactors. This eliminates the need for a current sensor within the charge circuit interrupt device. With such a system equipped with voltage sense circuits, during a short circuit, the voltage will drop to 0 v, which indicates a fault after which the contactors can be opened.

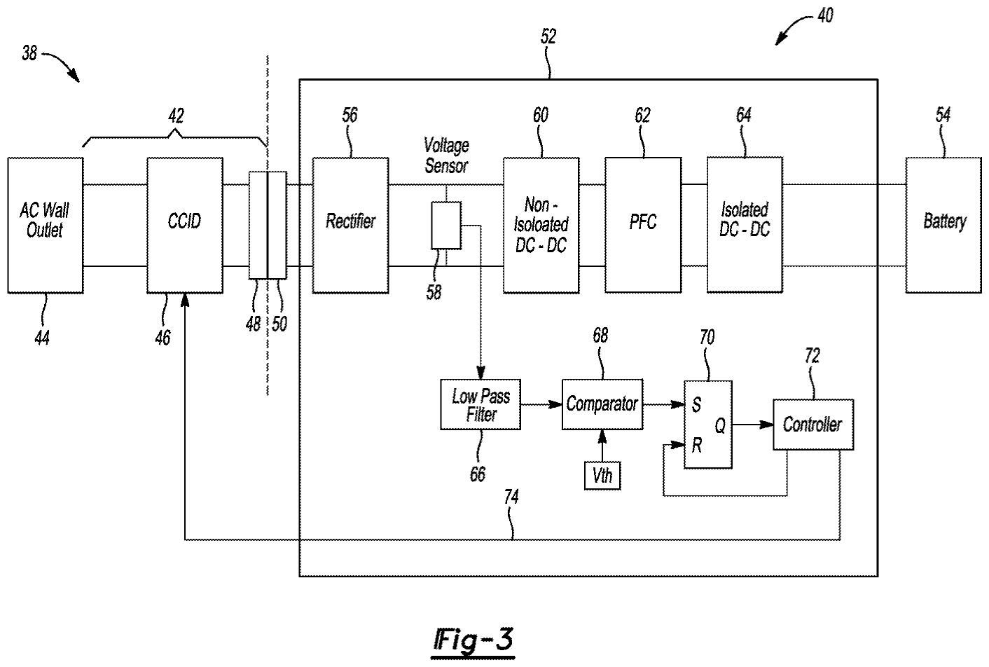

FIG. 3 shows a charge system 38 for a vehicle 40. The charge system 38 includes a cord set 42 connected with an AC wall outlet 44. The cord set 42 includes a charge circuit interrupt device 46 and a coupler 48. The vehicle 40 includes a vehicle inlet 50, an on board charger 52, and a high voltage (or traction) battery 54. The coupler 48 and vehicle inlet 50 mate with each other to establish an electrical connection between the AC wall outlet 44 and on board charger 52. Power from the AC wall outlet 44 delivered to the on board charger 52 via the cord set 42 during normal charging can then be used by the on board charger 52 to charge the high voltage battery 54.

The on board charger 52 includes a rectifier 56, a voltage sensor 58, a non-isolated DC-DC boost converter 60, power factor correction circuitry 62, and an isolated DC-DC boost converter 64. The on board charger 52 also includes a low pass filter 66, a comparator 68, a logic gate 70 (e.g., set-reset latch), and a controller 72. The voltage sensor 58, in this example, is arranged to measure voltage between the rectifier 56 and non-isolated DC-DC boost converter 60. Data from the voltage sensor 58 is filtered via the low pass filter 66 to attenuate a fundamental component of the measured voltage signal resulting in an AC signal this has a bias value corresponding to a voltage on the AC wall outlet 44. The comparator 68 compares a minimum value of the AC signal to a threshold value (e.g., 50V). Responsive to the minimum of the minimum value being less than the threshold value, the comparator 68, in this example, will issue a logical 1. Otherwise, the comparator will issue a logical 0. The logic gate 70, responsive to the comparator issuing a logical 1, will pass a 1 (or high signal) to the controller 72. Otherwise, the logic gate 70 will pass a 0 (or low signal) to the controller 72. Responsive to the logic gate 70 passing a 1, the controller 72 will issue a command to the CCID 46 to open its contractors. Responsive to the logic gate 70 passing a 0, the controller 72 will not issue such a command.

The charge circuit interrupt device 46 connects to the on board charger 52 through the coupler 48/inlet port 50. The controller 72 uses a control pilot circuit 74 that passes through the coupler 48/inlet port 50 to communicate voltage and current limits. The on board charger 52, which converts AC voltage to DC voltage, has the input rectifier stage before the boost converter stage to which the voltage sense circuits are added to monitor the input voltage as described above. If a short circuit occurs on the vehicle side, the voltage sense circuits will detect input voltage going down to 0V, after which the controller 72 commands the charge circuit interrupt device 46 to open the contactors therein to eliminate the AC input. Moreover, the techniques described herein differentiate zero crossing with AC line input and recognize a fault condition, and can be used with both Level 1 and Level 2 charging systems.

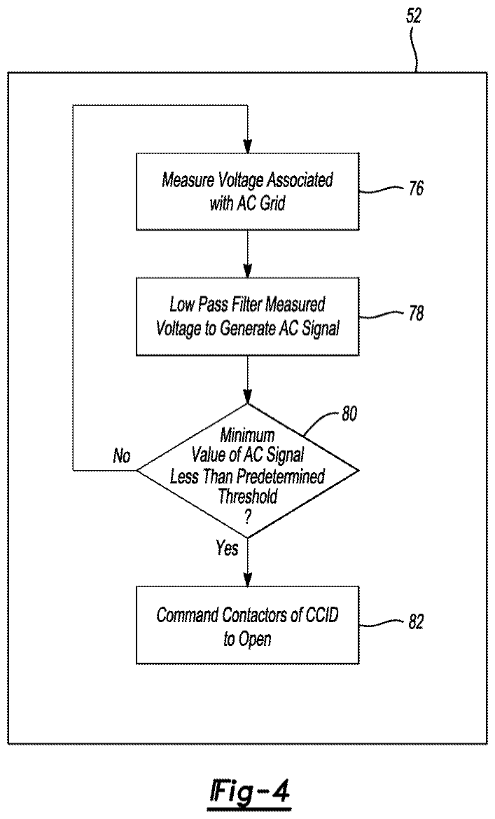

FIG. 4 shows operations that may be performed by the on board charger 52. At operation 76, voltage associated with the AC grid is measured at operation 76. The measured voltage is low pass filtered at operation 78 to generate an AC signal that has a bias value corresponding to a voltage on the AC grid. At operation 80, the algorithm proceeds to operation 82 if a minimum value of the AC signal is less than a predetermined threshold. If the minimum value of the AC signal is greater than the predetermined threshold, the algorithm returns to operation 76.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An automotive vehicle comprising:
a traction battery; and
an on board battery charger configured to be electrically connected with an off board AC grid via a charge cable that is connected between the automotive vehicle and AC grid and that includes a charge circuit interrupt device, wherein the on board battery charger is further configured to attenuate a fundamental component of a voltage signal associated with power from the AC grid to generate an AC signal that has a bias value corresponding to a voltage on the AC grid, and to issue a command to open contactors of the charge circuit interrupt device responsive to a minimum value of the AC signal being less than a predetermined threshold value.

2. The automotive vehicle of claim 1, wherein the on board battery charger includes a rectifier, a non-isolated DC-DC boost converter, and a voltage sensor connected between the rectifier and non-isolated DC-DC boost converter and configured to measure the voltage signal.

3. The automotive vehicle of claim 2, wherein the on board battery charger further includes an isolated DC-DC boost converter and power factor correction circuitry connected between the non-isolated DC-DC boost converter and isolated DC-DC boost converter.

4. The automotive vehicle of claim 1, wherein the on board battery charger further includes a filter configured to perform the attenuation of the fundamental component of the voltage signal.

5. The automotive vehicle of claim 4, wherein the filter is a low pass filter.

6. The automotive vehicle of claim 1, wherein the on board battery charger further includes a comparator configured to compare the minimum value with the predetermined threshold.

7. The automotive vehicle of claim 1, wherein the on board battery charger further includes a controller configured to generate the command.

8. A method for operating an on board battery charger of an automotive vehicle, wherein the on board battery charger is configured to be electrically connected with an off board AC grid via a charge cable that is connected between the automotive vehicle and AC gird and that includes a charge circuit interrupt device, the method comprising:
by the on board battery charger,
attenuating a fundamental component of a voltage signal associated with power from the AC grid to generate an AC signal that has a bias value corresponding to a voltage on the AC grid; and
issuing a command to open contactors of the charge circuit interrupt device responsive to a minimum value of the AC signal being less than a predetermined threshold value.

9. The method of claim 8 further comprising measuring the voltage signal.

10. The method of claim 8, wherein attenuating the fundamental component of the voltage signal includes filtering the fundamental component of the voltage signal.

11. The method of claim 10, wherein filtering the fundamental component of the voltage signal includes low pass filtering the fundamental component of the voltage signal.

12. The method of claim 8 further comprising comparing the minimum value with the predetermined threshold.

13. An automotive vehicle comprising:
a traction battery; and
an on board battery charger configured to be electrically connected with an off board AC grid via a charge cable that includes a charge circuit interrupt device, wherein the on board battery charger includes
a voltage sensor configured to measure a voltage signal associated with power from the AC grid,
a filter configured to attenuate a fundamental component of the voltage signal to generate an AC signal that has a bias value corresponding to a voltage on the AC grid,
a comparator configured to compare a minimum value of the AC signal with a predetermined threshold, and
a controller configured to issue a command to open contactors of the charge circuit interrupt device responsive to the minimum value being less than a predetermined threshold.

14. The automotive vehicle of claim 13, wherein the on board battery charger further includes a rectifier and a non-isolated DC-DC boost converter, and wherein the voltage sensor is connected between the rectifier and non-isolated DC-DC boost converter.

15. The automotive vehicle of claim 14, wherein the on board battery charger further includes an isolated DC-DC boost converter and power factor correction circuitry connected between the non-isolated DC-DC boost converter and isolated DC-DC boost converter.

16. The automotive vehicle of claim 13, wherein the filter is a low pass filter.

17. The automotive vehicle of claim 13, wherein the on board battery charger further includes a set-reset latch configured to receive input from the comparator and generate output for the controller.
